(19) United States
(12) Patent Application Publication
(10) Pub. No.: US 2009/0182668 A1
(43) Pub. Date: Jul. 16, 2009

(54) METHOD AND APPARATUS TO ENABLE LAWFUL INTERCEPT OF ENCRYPTED TRAFFIC

(75) Inventor: Michael LEE, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: NORTEL NETWORKS LIMITED, St. Laurent (CA)

(21) Appl. No.: 12/347,212

(22) Filed: Dec. 31, 2008

Related U.S. Application Data
(60) Provisional application No. 61/010,805, filed on Jan. 11, 2008.

(51) Int. Cl. G06Q 10/00; H04L 9/30; H04L 9/08; H04L 9/32; G06Q 50/00

(52) U.S. Cl. 705/50; 380/275; 380/30; 380/285; 380/286

(57) ABSTRACT

Methods and systems are described for communicating the session keys used to encrypt media stream to allow a lawful intercept agency to decrypt the media stream. Assuming the endpoints negotiate the session keys themselves, the send an encrypted format key message which is encrypted with an encryption key for which only the LI agency knows the corresponding decryption key. However, to avoid abuse by the LI agency, or even to avoid the perception that LI agencies can intercept private calls without due process, the media session key is further encrypted with at least one additional key, with the corresponding decryption key(s) being unknown to the LI agency.

### CROSS REFERENCE TO RELATED APPLICATIONS

This application claims the benefit of priority of U.S. Provisional Patent Application No. 61/010,805 filed Jan. 11, 2008, which is incorporated herein by reference.

### FIELD OF THE INVENTION

The present invention relates generally to privacy and encryption of media traffic over data networks, and in particular, voice traffic over data networks, for example voice over IP (VoIP).

### BACKGROUND OF THE INVENTION

With the advent of voice and other multimedia over data networks (e.g. voice over IP (VoIP)), there have been privacy concerns, especially when such traffic is transmitted over the public internet. Voice over IP and multimedia traffic is susceptible to an attacker recording traffic, rerouting traffic or using malware programs to eavesdrop on the traffic. This has been a concern and various parties (e.g., standard bodies) are working on solutions to prevent eavesdropping and are trying to ensure that private communications remain private. For example, in order to prevent eavesdropping and provide privacy for the end user, SIP and H.323 multimedia traffic is now being encrypted using strong cryptographic methods. One method gaining widespread acceptance is the use of Secure Real Time Protocol (SRTP). Within SRTP the multimedia traffic is encrypted with Advanced Encryption Standard (AES) cryptography with a 128 bit or greater key length. However, the use of such strong encryption prevents even lawfully authorized agencies from decrypting this data without having access to the key due to the huge numbers of possible key combinations. (E.g., 128 bit keys have 2 to the power of 128 possible key combinations).

Also, since key exchanges are now being negotiated between endpoint terminals directly, there is no opportunity for the service provider or a lawful intercept agency such as the FBI, CIA, NSA, CISIS, or other lawfully authorized bodies to obtain the session keys in order to perform lawful intercept.

It is, therefore, desirable to provide a mechanism which will protect the privacy of callers, while still allowing for lawful intercept (LI) by lawfully authorized agencies.

### SUMMARY OF THE INVENTION

The present invention provides a mechanism which will protect the privacy of callers, while still allowing for lawful intercept (LI) by lawfully authorized agencies (hereafter LI agency).

One aspect of the invention provides a method and system for communicating the session keys used to encrypt the media stream such that it is possible for a lawfully authorized agency to lawfully intercept and decrypt the media stream. Assuming the endpoints negotiate the session keys themselves, the endpoints are responsible for communicating said media session key. Accordingly at least one of said endpoints communicates said media session key to at least one 3^{rd} party to allow for lawful intercept (LI) by an LI agency. In order to ensure that only a lawfully authorized agency can intercept the traffic, according to one embodiment of the invention, the endpoints send the media session key in an encrypted format key message.

In one embodiment the at least one 3^{rd} party is the LI agency itself, in which case, the encrypted format key message is encrypted with an encryption key for which only the LI agency knows the corresponding decryption key. In such an embodiment, such an encrypted format key message can be decrypted directly by the LI agency. However, to avoid abuse by the LI agency, or even to avoid the perception that LI agencies can intercept private calls without due process, the at least one 3rd party can comprise one or more intermediary and/or additional parties, according to alternative embodiments of the invention. In such cases, the encrypted format key message encrypts the media session key using at least one additional key, with the corresponding decryption key(s) being unknown to the LI agency. For example, the co-operation of a service provider (e.g., an internet service provider or carrier) associated with at least one of the endpoints can be required before the LI agency can decrypt the encrypted format key message. In such an example, the encrypted format key message is encrypted both by a key associated with the LI agency, and in addition, with a key associated with the service provider (i.e., only the service provider knows the corresponding decryption key). Therefore, the LI agency can not intercept the traffic without the cooperation of the service provider. In order to avoid abuse by collusion between the LI agency and the service provider, more than one additional party can be required.

In some jurisdictions, Lawful intercept requires a court order before a LI agency can lawfully intercept a private call. In such a jurisdiction, decryption of the encrypted format key message by the court (or an appointed agent) can be required, by encrypting the encrypted format key message with a key associated with the court (i.e., only the court (or an authorized agent) knows the corresponding decryption key). As an alternative, if there are several government agencies within a jurisdiction, such as the US with (FBI, CIA, or NSA), the courts (or an appointed agency) or some other authority can act as the LI agency itself, and provide the decrypted media key to the appropriate agency if a court order is obtained. This prevents the need for each media stream to be encrypted with a key for each possible LI agency.

An aspect of the invention provides for a method of securing a media stream between first and second endpoints of a packet data network, while still allowing lawful intercept, comprising: a) endpoints negotiating a media session key for encrypting said media stream; b) endpoints encrypting said media stream with said media session key to produce an encrypted media stream; and c) at least one of said endpoints creating and transmitting an encrypted message which contains the media session key encrypted with a first additional key for which the corresponding decryption key is known by a lawful intercept (LI) agency. According to one embodiment step (c) comprises further encrypting said media session key using at least one additional key with a corresponding decryption key not known by said LI agency.

In one embodiment, the encrypted format key message can be sent via a signaling channel. In alternative embodiments, the encrypted format key message can be transmitted between said parties in the same media plane which carries the media stream. In one exemplary embodiment, we introduce a new type of media stream packet which we call a tracer packet. Such a tracer packet is sent after some number (n) of media stream packets, and includes the encrypted key in its payload. Additional information can be included in said tracer packet to assist the LI agency in intercepting the call, or in subsequently demonstrating (e.g, to a court of law) that the call has not been altered or fabricated by the LI agency.

As well as the methods described herein, aspects of the invention are directed to the endpoint devices and/or call servers/media gateways or network intercept points which carry out the methods, and also to computer program products tangibly embodied in computer readable mediums which contain computer executable instructions for causing said devices to execute the methods described and claimed herein. For example, one aspect of the invention provides for data network multimedia apparatus for transmitting encrypted media while still allowing for lawful intercept (LI) comprising: a) a call signaling module for establishing a call with another endpoint; b) a key negotiation module for negotiating a media session key with said another endpoint; c) an encryption module for encrypting media traffic with said negotiated media session key; and d) a LI module for creating and transmitting an encrypted message which contains the media session key encrypted with a first additional key for which the corresponding decryption key is known by a lawful intercept (LI) agency.

Another aspect of the invention provides for a multimedia/VoIP terminal apparatus for securely transmitting a media stream to a second endpoint of a packet data network, while still allowing lawful intercept, comprising: a) means for negotiating a media session key for encrypting said media stream; b) means for encrypting said media stream with said media session key to produce an encrypted media stream; and c) means for creating and transmitting an encrypted message which contains the media session key encrypted with a first additional key for which the corresponding decryption key is known by a lawful intercept (LI) agency. According to one embodiment said means for creating comprises means for further encrypting said media session key using at least one additional key with a corresponding decryption key not known by said LI agency.

A Network Intercept Apparatus for intercepting a composite encrypted media stream transmitted via a data network, said composite encrypted media stream including encrypted media stream packets encrypted with a media session key and tracer packets which include an encrypted media session key which is encrypted with an additional key, said apparatus comprising: a data network interface which provides a logical and physical interface to the data network; a target mirroring module which replicates an encrypted media stream targeted for lawful intercept (LI) and separates said tracer packets from said encrypted media stream packets; a tracer packet processing module which isolates said encrypted media session key from within the tracer packet and performs decryption of the media session key using the additional key and reassembles each tracer packet to include the decrypted media session key; and a LI Media Stream Packet Processing Module which receives the outputs from both the Tracer Packet Processing Module and the Target Mirroring Module and re-inserts the reassembled tracer packets within the replicated encrypted media stream.

Other aspects and features of the present invention will become apparent to those ordinarily skilled in the art upon review of the following description of exemplary embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a schematic illustration of a network which provides for secure communications, but which allows for LI, according to an embodiment of the invention.

FIG. 2 is a block diagram illustrating the components of an exemplary data network multimedia apparatus, according to an embodiment of the invention.

FIG. 3 is a flowchart of an exemplary process executed by a processor of the terminal 30 according to an embodiment of the invention.

FIG. 4 is a flowchart of an exemplary process carried out by a carrier lawful intercept point processor, according to an embodiment of the invention.

FIG. 5 is a schematic figure illustrating both a media stream packet and a tracer packet according to an embodiment of the invention.

FIG. 6 is a schematic figure illustrating both a raw tracer packet and the corresponding encrypted packet.

FIG. 7 is a block diagram of a Carrier Lawful Intercept point, according to an embodiment of the invention.

FIG. 8 is a block diagram illustrating the components of an exemplary Media Gateway apparatus, according to an embodiment of the invention.

### DETAILED DESCRIPTION

Generally, the present invention provides methods and systems for protecting the privacy of callers, while still allowing for lawful intercept by lawfully authorized agencies.

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention. For example, specific details are not provided as to whether the embodiments of the invention described herein are implemented as a software routine, hardware circuit, firmware, or a combination thereof.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium, including magnetic, optical, or electrical storage medium including a diskette, compact disk read only memory (CD-ROM), memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine readable medium may interface with circuitry to perform the described tasks.

Embodiments of the invention will be described based on the non-limiting example of a VoIP configuration, but it should be appreciated that the examples described herein can be extended to other voice over data network applications, or indeed to multimedia (e.g., a video conference call) over data networks in general

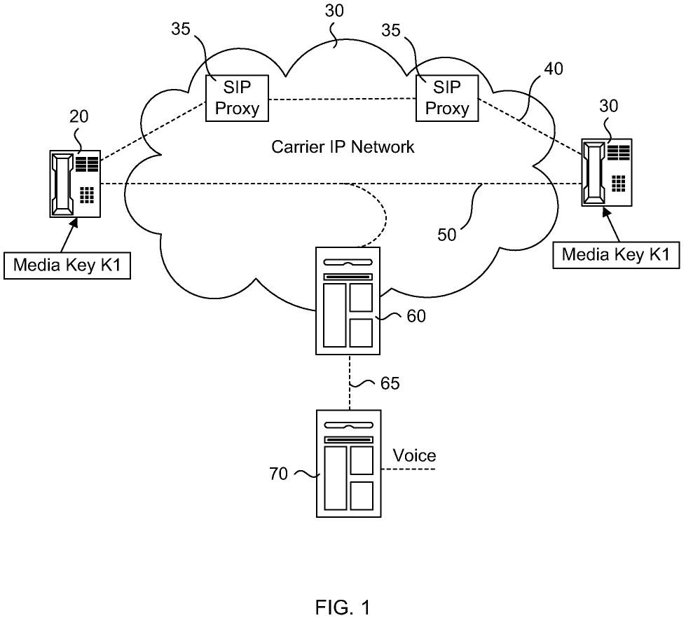

FIG. 1 is schematic illustration of a network which provides for secure communications, but which allows for LI, according to an embodiment of the invention. In FIG. 1, a data network multimedia terminal, for example VoIP phone 20, communicates with another terminal 30 via a data network, for example carrier IP network 30. A call is set up via signalling channel 40 and SIP proxies 35. The terminals negotiate a media key K1 and the media stream is transmitted via the IP network 30 using a media plane 50 which was established during call setup. The carrier IP network 30 includes at least one carrier lawful intercept point 60 which has access to the media stream 50. The intercept point 60 is in communication with the government lawful intercept agency network element 70.

The terminals 20 and 30 are configured to embed tracer packets in the encrypted media stream 50. These tracer packets include an encrypted media stream key K1 which is encrypted with the public key of the carrier and the public key of the government LI agency. Carrier intercept point 60 decrypts the tracer with the carrier private key and re-embeds the tracer in a message which is sent either directly or indirectly to the LI agency node 7, for example, via path 65. However, it should be appreciated that the LI agency 70 could also have access to the media stream 50 and it is able to decrypt the tracer packets which the carrier lawful intercept point re-embeds within the media stream.

The government LI agency node decrypts the tracer packet with the LI private key to recover K1. This allows the LI agency to decrypt the voice with K1 thus making lawful intercept possible. As stated, the carrier participation prevents abuse by, or the perception of abuse by, the LI agency by preventing the LI agency to obtain the media key K1 covertly. As stated, this is just one embodiment and more than two keys can be used to encrypt the media key K1 within the tracer packet. For example, a court or privacy agency, or an agent thereof, could supplement the carrier lawful intercept to ensure that the lawful intercept agency follows due process before being able to obtain the tracer packet in a format in which it can decrypt. In addition, as a further alternative, multiple parties can be required to decrypt the tracer packet, each with their own key which is unknown to the LI agency or the other parties, to further ensure that the lawful intercept is indeed lawful. It should be appreciated that the Carrier Intercept point is not actually necessary, and the abuse (and the perception of abuse) can be prevented by having the courts and/or some other privacy agency operate the intercept point. The point is to require the co-operation of at least one additional party, so that the LI agency can not decrypt the media stream unilaterally. However, if abuse is not a concern, then the tracer packet need only be encrypted with the LI key, and the LI agency node 70 can directly decrypt the tracer packet, and thus the media stream.

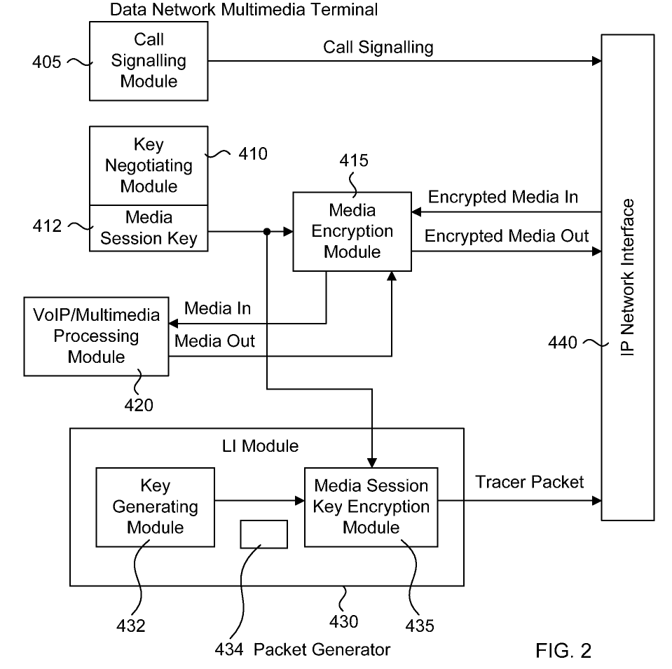

FIG. 2 is a block diagram illustrating the components of an exemplary data network multimedia apparatus, according to an embodiment of the invention. It should be appreciated that such a network endpoint apparatus can comprise a personal computer or cellular/wireless/PDA (or other device) executing an appropriate VoIP client, or a dedicated VoIP phone. Accordingly, the functional blocks can represent a combination of hardware (CPU or other processors and associated computer readable memory, ASICs, DSPs etc) executing appropriate software.

In FIG. 2, the IP Network Interface 440 provides the packet assembly and logical and electrical interface to the IP network. The Call Signaling Module 405 performs all call signaling functions in order to set up, control and terminate voice and multimedia sessions, using SIP, H.323 or another suitable multimedia protocol. VoIP/Multimedia Processing Module 420 performs VoIP and multimedia processing as per a typical VoIP/multimedia terminal including such functions a de-multiplexing voice and data information, performing audio processing, keypad and other input device processing, LCD or other screen output device processing, audio tone generation, etc. Key Negotiating Module 410 performs key exchange or key negotiation with another endpoint to derive a media session key 412 for a particular VoIP/multimedia session. The Key Negotiating Module 410 communicates with one or more endpoints using the IP Network Interface 440, either directly via a bus or other link between 410 and 440 (not shown), or indirectly or via the Call signaling Module 405.

Media Encryption Module 415 performs encryption on the VoIP or multimedia stream using the media session key 412. Encryption may be performed under the secure real time protocol (SRTP), IPsec, DTLS or other encryption protocol. Media Encryption Module 415 also performs media decryption of incoming VoIP or multimedia information.

In addition to the above components, which are for the most part conventional, the endpoint also includes an LI Module 430 which produces the encrypted format key message which includes the encrypted media session key which is decrypted by the LI agency in order to decrypt the media stream. According to the embodiment illustrated in FIG. 2, the encrypted format key message is inserted within the payload of a tracer packet which is transmitted between the parties in the same media plane which carries the media stream.

LI module 430 comprises Key Generating Module 432, Media Session Key Encryption Module 435, and a packet generator 434 which produces the header and other payload information of the tracer packet.

Key Generating Module 432 generates and/or stores the key(s) used for tracer packet encryption. The number of keys (M) which are generated and/or stored depends on the number of 3^{rd} parties which are required to co-operate with a LI agency in order to perform LI. According to one embodiment, asymmetric encryption is used, in which case the key generation process comprises the Key Generating Module 432 looking up public keys of the carrier, LI agency and other optional authorized bodies. It should be noted, that this can be done for each session, or alternatively, if these keys do not change very often, they can be stored within an internal database, which is updated as the keys are changed by the corresponding 3^{rd} party.

According to an alternative embodiment, symmetric encryption is used, in which case the key generation module 432 performs key negotiation with each authorized body using a secure protocol such as IKE (internet key exchange), authenticated Diffie-Hellman or other protocol.

Media Session Key Encryption Module 435 performs M encryptions on the payload of the tracer packet which includes the media session key, and optionally, other tracer packet information. Encryptions are performed using either asymmetric encryption algorithms such as RSA or symmetric encryption algorithms such as AES, 3-DES, Blowfish, or many others.

Once the payload is encrypted, the tracer packet is transmitted to the other endpoint using the same media plane as the media stream via IP network Interface 440

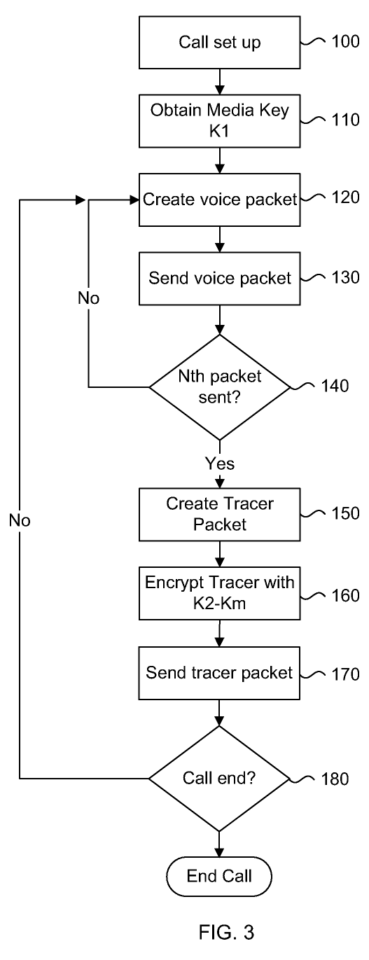

FIG. 3 is a flowchart of a process executed by a processor of the terminal 30 according to an embodiment of the invention. First, the call is set up 100 between endpoint 20 and endpoint 30, by call signaling module 405, according to a network signaling protocol, such as SIP or H.323, in a conventional manner. This establishes a media plane 50 between the endpoints 20 and 30. The key negotiating module 410 obtains a session media key (K1) 110, typically via negotiation with endpoint 20. This key negotiation can occur over the signaling channel 40 via the appropriate signaling protocol. Alternatively, the key negotiation can occur over the media plane 50, which is more secure, as it is harder to intercept a key negotiated over the media plane, than one negotiated over the signaling channel

Once the call is established, the VoIP Processing module 420 creates each voice packet 120, and then each voice packet is transmitted 130 via IP network interface 440. However a controller for the endpoint 30 checks whether a transmitted packet is the Nth packet since the last tracer packet has been transmitted 140. If not, voice packets are created and sent until the Nth speech packet is sent. After the Nth packet is transmitted, the LI module 430 creates a tracer packet 150, which comprises a header, and payload. The payload includes the media session key 412, and optionally other information, as will be discussed below. The payload is then encrypted 160 via the Media session encryption module 435, and then transmitted 170 via the IP network interface 440.

The process of creating and sending speech packets, with every Nth packet being a tracer packet, continues until the call is ended 180.

We point out that although the Carrier Interception point is shown and described as separate network node, this is not necessary. The appropriate functions can be executed by a processor of a carrier router (and preferably an edge router, so that the core routers do not need to be upgraded) or a firewall at the carrier's edge. Furthermore this functionality can be split between nodes. For example, the edger router can monitor for the presence of the tracer packet, and alert or deny the media stream if the tracer packets are not present, whereas one (or more) dedicated LI point(s) performs the decryption and packet re-assembly if necessary.

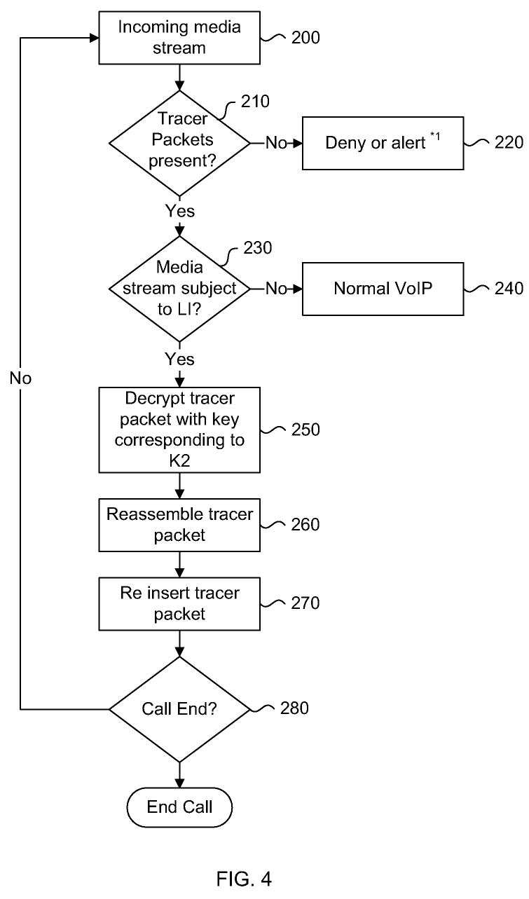

FIG. 4 is a flowchart of a process carried out by a carrier lawful intercept point processor, accordingly to an embodiment of the invention. For this embodiment the processor first receives the incoming media stream 200 and evaluates whether the tracer packets are present (e.g., by detecting whether there packets which contain a tracer header). If there is no tracer packet present, then various treatments 220 can be applied depending on the embodiment, and also depending on the legal requirements of the jurisdiction. For example, it is possible that the processor can deny transport of the media stream for non-compliance with the requirement to include the tracer packets. Alternatively, an alert can be made stating that the media stream is not compliant, and this alert can be sent to a management station to alert service provider personnel that a security policy violation may be occurring.

Assuming the tracer packets are present, then the processor will evaluate whether the media stream is subject to LI enforcement 230. If not, then normal VoIP processing and routing occurs 240. Depending on the embodiment, and also on the requirements of the jurisdiction, the media stream can be stored for subsequent review by a law enforcement agency if there is no real time requirement for lawful intercept.

However, if there is real time requirement of lawful intercept then the processor will decrypt the tracer packet with a key corresponding to K2 (that is to say the carriers decryption key) 250. The processor then will reassemble the tracer packet with the decrypted payload 260. Note that this payload will still be encrypted with the law enforcement key, and potentially other keys if there are additional third party encryptions applied to the media stream. The processor will then reinsert the tracer packet into the media stream (that is to say apply the appropriate headers to the decrypted payload) and transmit the tracer packet. This continues until the call is ended 280.

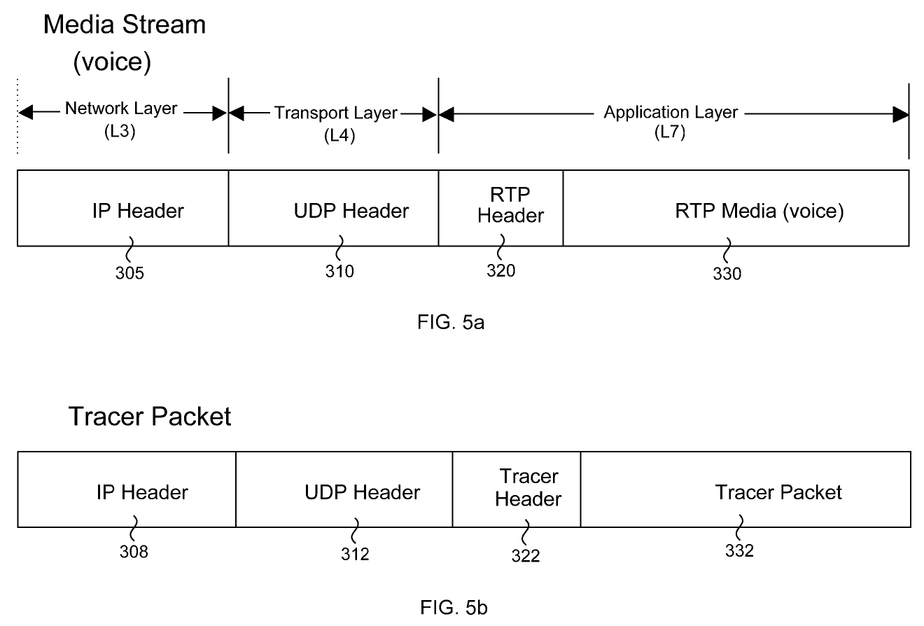

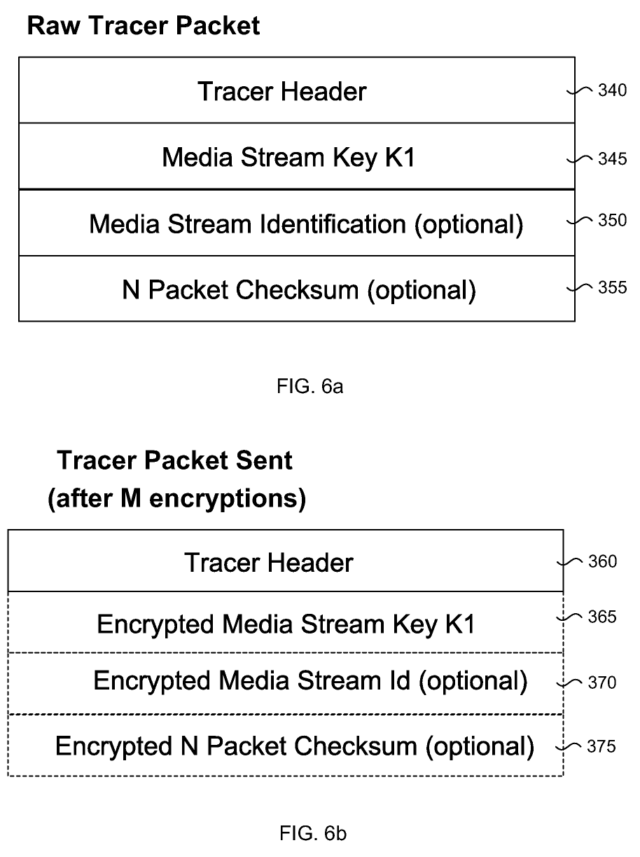

FIGS. 5 and 6 are schematic drawings showing details of the media stream and tracer packet. FIG. 5 shows the various components of both a media stream packet and a tracer packet at the Network Layer (L3), Transport Layer (L4) and the Application Layer (L7). FIG. 5a shows a media stream packet with an IP Header 305, a UDP Header 310 an RTP Header 320 and an RTP Media payload 330, which for a voice over IP call, will be the VoIP data.

FIG. 5b shows a corresponding tracer packet which will be inserted into the media stream every N packets. The tracer packet comprises an IP Header 308, a UDP Header 312, a Tracer Header 322 which identifies the packet as a tracer packet and an encrypted Tracer Packet payload 332.

FIG. 6a shows a raw tracer packet comprising a Tracer Header 340 and a payload which comprises the media stream key 345 and optionally a media stream identification information 350 as well as optionally a checksum of the previous N packet 355. FIG. 6b shows the corresponding encrypted packet after M encryptions where M represents the number of third parties. Here the encrypted payload comprises the encrypted media stream key 365 and if the media stream identification information 350 and N packet checksums 355 were included in the original packet, then the encrypted packet will also include the encrypted media stream identification information 370 and the encrypted N packet checksum 375.

The checksum may be used by the LI agency to ensure that the packets in the media stream have not been modified and do indeed correspond to the tracer packet for those N packets. As the tracer packet is different for each N media stream packets, it has and has to be recalculated by the phone or client for each tracer packet. Accordingly, the checksum is an optional field since it represents higher overhead.

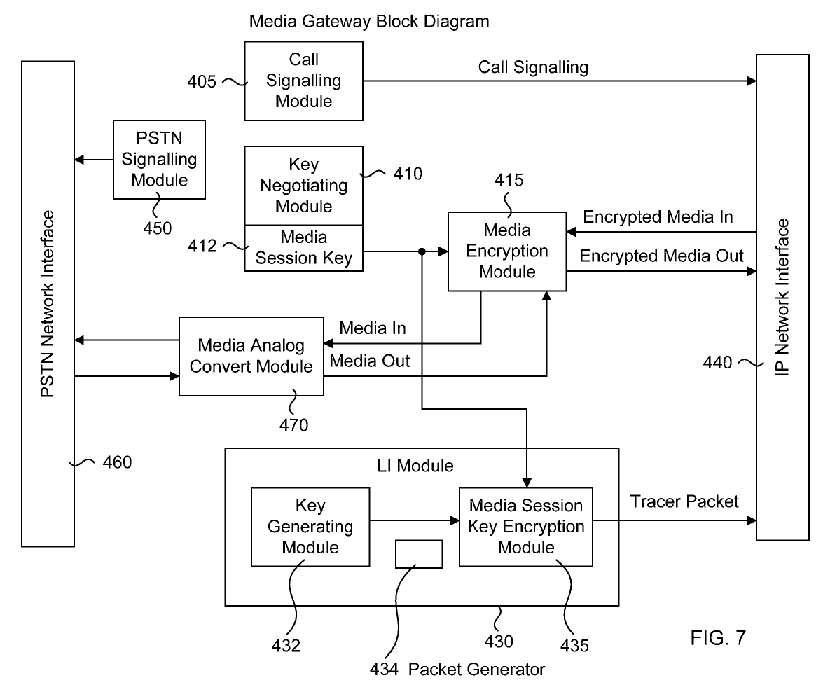

FIG. 7 is a block diagram of an exemplary Network Intercept Apparatus, for example a Carrier Lawful Intercept point, according to an embodiment of the invention. It comprises an Data network interface 500 which provides a logical and physical (e.g., electrical) interface to the IP network for receiving and transmitting media streams. In some embodiments, it also performs packet assembly. The Target Mirroring Module 510 receives all composite media streams, which contain the encrypted media streams and their corresponding tracer packets. It will isolate the particular composite media streams that have been targeted for LI and replicates (copies) the targeted composite media stream. The original stream is then transmitted unchanged to its original destination based on its IP address. For each such replicated stream, Target Mirroring Module 510 separates the tracer packets and encrypted media stream packets from the targeted composite media stream. It then forwards the tracer packets to the Tracer Packet Processing Module 520.

Tracer Packet Processing Module 520 records any relevant information from tracer packets such as the optional identification information and checksum. It then isolates encrypted media session key from within the tracer packet and performs partial decryption of the media session key using the Carrier Key. Note the Carrier key will be the Carrier's private key if asymmetrical encryption is used, and will be a secret key shared with the endpoint if a symmetric key encryption is used. It then reassembles each tracer packet to include the partially decrypted media session key.

LI Media Stream Packet Processing Module 530 receives the outputs from both the Tracer Packet Processing Module 520 and the Target Mirroring Module 510. It then changes the IP address of all packets to route these to the LI agency. The processing module 530 then re-inserts the reassembled tracer packets within the replicated encrypted media stream.

Note that the LI media stream packet processing module may do this processing in real time or in alternative embodiment, may store and delay the media stream temporarily and process in non real time.

Note that FIG. 1 illustrates a scenario where both ends of a call are VoIP terminals. However, it is possible that only one end of a call is a VoIP terminal, with the other end being a PSTN phone, in which case a Media Gateway is involved in the call at the border between the IP network and the PSTN (Public Switched Telephone Network). Furthermore, although the PSTN end is subject to more conventional wire tapping, this may not be feasible, especially if the LI agency is interested in monitoring a suspected terrorist or other party who is calling using the VoIP terminal, and not some unknown called party. The Media Gateway represents the end of a data call, at least for the purposes of intercepting an encrypted call.

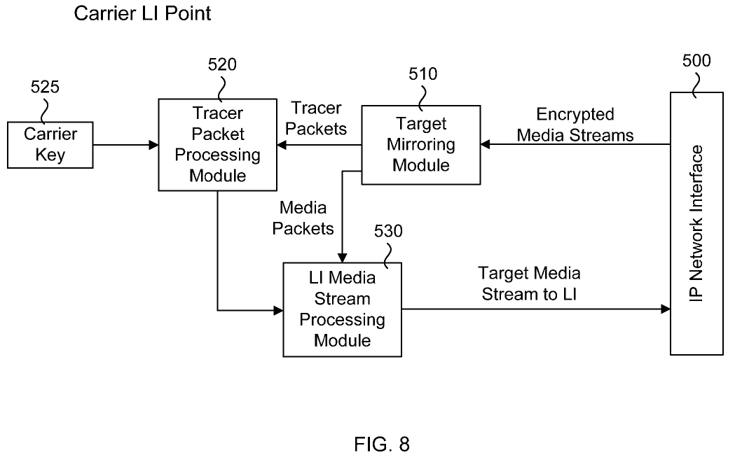

FIG. 8 is a block diagram illustrating the components of an exemplary Media Gateway apparatus, according to an embodiment of the invention. FIG. 8 is very similar to FIG. 2, with functional equivalents to the components shown in FIG. 2, except the VoIP processing module 420 is replaced with a Media Analog Convert Module 470, a PSTN Signaling Module 450, and a PSTN Network Interface 460. The PSTN Signaling Module 450 performs signaling with the PSTN network. It translates signaling commands from an IP to PSTN network format and vice versa. The Media Analog Convert Module 470 performs voice processing on the VoIP digital information and converts this to an analog format to meet PTSN specifications, and vice-a-versa. The Media Analog Convert Module 470performs D/A conversion, A/D conversion, level shifting, and other interface functions. The PSTN Network Interface 460 provides the electrical interface to the PSTN network.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of securing a media stream between first and second endpoints of a packet data network, while still allowing lawful intercept, comprising:
a) endpoints negotiating a media session key for encrypting said media stream;
b) endpoints encrypting said media stream with said media session key to produce an encrypted media stream; and
c) at least one of said endpoints creating and transmitting an encrypted message which contains the media session key encrypted with a first additional key for which the corresponding decryption key is known by a lawful intercept (LI) agency.

2. The method as claimed in claim 1, wherein step (c) comprises further encrypting said media session key using at least one additional key with a corresponding decryption key not known by said LI agency.

3. The method as claimed in claim 2, wherein said at least one additional key comprises a second additional key, said second additional key having a corresponding second decryption key known by a service provider of at least one of said endpoints, and step (c) comprises encrypting said media session key with each of first and second additional keys such that both said LI agency and said service provider must co-operate by each separately decrypting said encrypted format key message in order to obtain said media stream key.

4. The method as claimed in claim 3, wherein said encrypted format key message is transmitted via a signaling channel.

5. The method as claimed in claim 3, wherein step (c) comprises inserting said encrypted format key message within the payload of a tracer packet and transmitting said tracer packet in the same media plane which carries said media stream.

6. The method as claimed in claim 5, wherein said tracer packet contains additional information useful for proving data integrity of the media stream.

7. The method as claimed in claim 6, wherein, said tracer packet is inserted after every n media stream packets are transmitted within the media plane.

8. The method as claimed in claim 3, wherein said encrypted media stream is stored for subsequent decryption by said LI agency.

9. The method as claimed in claim 3 wherein the end user device for said endpoints is configured to ignore tracer packets in the media stream.

10. The method as claimed in claim 3, wherein said at least one additional key comprises a second additional key, and at least one privacy key, said second additional key having a corresponding second decryption key known by a service provider of at least one of said endpoints, and said at least one privacy key having a corresponding privacy decryption key known only by a privacy agency, and step (c) comprises encrypting said media session key with each of first and second additional keys and said at least one privacy key such that each of said privacy agency, LI agency and said service provider must co-operate by each separately decrypting said encrypted format key message in order to obtain media stream key.

11. The method as claimed in claim 10 wherein said privacy agency is a court appointed agent whose key is needed to prevent unlawful intercept by a LI without a court order

12. A data network multimedia apparatus for transmitting encrypted media while still allowing for lawful intercept (LI) comprising:
a. a call signaling module for establishing a call with another endpoint;
b. a key negotiation module for negotiating a media session key with said another endpoint;
c. an encryption module for encrypting media traffic with said negotiated media session key;
d. a LI module for creating and transmitting an encrypted message which contains the media session key encrypted with a first additional key for which the corresponding decryption key is known by a lawful intercept (LI) agency.

13. A data network multimedia apparatus as claimed in claim 12 wherein said LI module comprises an additional key generating module and a media session key encryption module for encoding said media session key in an encrypted format key message using said first additional key.

14. A data network multimedia apparatus as claimed in claim 13
wherein said additional key generating module further comprises a database storing said first additional key and a privacy key;
wherein said media session key encryption module is configured to encrypt said media session key multiple times sequentially using each of said first additional and privacy keys; and
wherein said privacy key has a corresponding privacy decryption key known by a privacy agency, such that each of said privacy agency and said LI agency must co-operate by each separately decrypting said encrypted format key message in order to obtain media stream key.

15. A data network multimedia apparatus as claimed in claim 13
wherein said additional key generating module further comprises a database storing said first additional key, a second additional key and said privacy key;
wherein said media session key encryption module is configured to encrypt said media session key multiple times sequentially using each of said first and second additional keys and said privacy key; and
wherein said second additional key has a corresponding second decryption key known only by a service provider for said data network multimedia apparatus, and said privacy key has a corresponding privacy decryption key known only by a privacy agency, such that each of said privacy agency, LI agency and said service provider must co-operate by each separately decrypting said encrypted format key message in order to obtain media stream key.

16. A data network multimedia apparatus as claimed in claim 13 wherein said LI module further comprises a packet generator for inserting said encrypted format key message within the payload of a tracer packet and transmitting said tracer packet in the same media plane which carries said media stream.

17. A Network Intercept Apparatus for intercepting a composite encrypted media stream transmitted via a data network, said composite encrypted media stream including encrypted media stream packets encrypted with a media session key and tracer packets which include an encrypted media session key which is encrypted with an additional key, said apparatus comprising:
a data network interface which provides a logical and physical interface to the data network;
a target mirroring module which replicates an encrypted media stream targeted for lawful intercept (LI) and separates said tracer packets from said encrypted media stream packets;
a tracer packet processing module which isolates said encrypted media session key from within the tracer packet and performs decryption of the media session key using the additional key and reassembles each tracer packet to include the decrypted media session key; and
a LI Media Stream Packet Processing Module which receives the outputs from both the Tracer Packet Processing Module and the Target Mirroring Module and re-inserts the reassembled tracer packets within the replicated encrypted media stream.

18. A Network Intercept apparatus as claimed in claim 17 wherein said encrypted media session key is encrypted with at least one further key, and said tracer packet module only partially decrypts said media session key with said additional key to produce a partially decrypted media session key which is still partially encrypted with said at least one further key.

19. A Network Intercept apparatus as claimed in claim 18 wherein said at least one further key is a key for which an LI agency possesses a corresponding decryption key, and wherein said LI Media Stream Packet Processing changes the IP address of all packets in the replicated encrypted media stream to route the replicated encrypted media stream to said LI agency.

20. A Network Intercept apparatus as claimed in claim 19, wherein said Network Intercept apparatus forms part of a carrier edge router.
